(19) United States
(12) Patent Application Publication
(10) Pub. No.: US 2008/0265665 A1
(43) Pub. Date: Oct. 30, 2008

(54) Brake System for Motor Vehicles

(75) Inventor: Stefan Drumm, Saulheim (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 11/884,157

(22) PCT Filed: Feb. 15, 2006
(86) PCT No.: PCT/EP2006/050956

§ 371 Date: Apr. 2, 2008

(30) Foreign Application Priority Data
Feb. 18, 2005 (DE) 10 2005 007 448.0

(51) Int. Cl. B60T 8/40; B60T 13/14

(52) U.S. Cl. 303/116.4

(57) ABSTRACT

To allow boosting the actuating force even if the control electronics or the electric energy supply fails in a brake-by-wire system, a piston (8) which can be acted upon by two oppositely directed forces by way of an elastic element (6, 7) on the input side and by hydraulic pressure in the space (11) on the outlet side. An arrangement (14, 19, 15) renders the pressure-supplying module (9) controllable depending on the position of the piston (8) that results from the force application, in addition to the electric controllability.

### BACKGROUND OF THE INVENTION

The present invention relates to a brake system for motor vehicles with a brake-by-wire system. In particular, the brake system has a master cylinder with a master cylinder housing to which wheel brake cylinders are connectable,

a first piston which is coupled to a brake pedal by way of a push rod that transmits actuating forces,

a second piston used to actuate the master cylinder,

a third piston which can be actuated hydraulically by the first piston,

with at least one elastic element forming a pedal travel simulator that imparts a pleasant pedal feeling to the operator in the ‘brake-by-wire’ operating mode,

an arrangement to couple the movements of the first piston and the third piston,

a space to which hydraulic pressure is applicable, whose pressurization brings about a hydraulic action of force on the second piston and the third piston,

as well as an electrically controllable pressure-supplying module, which allows both filling the space with pressure fluid and evacuating it.

‘Brake-by-wire’ brake systems are employed in motor vehicle technology at an increasing rate. In the brake systems, the brake can be actuated ‘independently’ in response to electronic signals without any action on the part of the driver. The electronic signals can be output by an electronic stability program ESP or a collision avoidance system ACC, for example. When an independent actuation of this type is superposed on an actuation done by the driver, the driver of the motor vehicle notices a reaction in the brake pedal. This reactive effect on the brake pedal can be surprising and unpleasant for the driver so that, in a critical situation in traffic, the driver will not apply the brake pedal to an extent that complies with this situation because the reaction to the brake pedal that is due to the independent actuation of the brake is irritating him.

DE 10 2004 025 638 A1 discloses a brake system of the type mentioned hereinabove. An ‘independent actuation’ of the prior-art brake system or pressurization of the space is executed in the ‘brake-by-wire’ operating mode by the electrically controllable pressure-supplying module using a likewise electrically operable valve device, which opens or closes a hydraulic connection between the space and the pressure-supplying module. The fact is considered disadvantageous in the prior-art brake system that boosting of the actuating force generated by the operator is only possible when the electronic unit and the energy supply (battery, and electrical wiring system) provided in the vehicle are intact.

In view of the above, an object of the invention is to disclose a brake system of the type initially referred to, wherein the actuating force is boosted, even if the electronic control unit or the electric energy supply fail, as long as until the energy reserves of an energy accumulator inside the brake system are exhausted. The brake system disclosed permits the driver to slow down the vehicle in a safe way also in this operating condition with the customary pedal force.

### SUMMARY OF THE INVENTION

According to the invention, this object is achieved in that a fourth piston is provided, which can be acted upon by two oppositely directed forces by way of the elastic element on the input side and by the hydraulic pressure in the space on the outlet side, and that a means is provided in order to render the pressure-supplying module controllable depending on the position of the fourth piston that results from the force application, in addition to the electric controllability.

To render the idea of the invention more precise, arrangements are made that the means for controlling the pressure-supplying module depending on the position of the fourth piston comprises a both mechanically and electrically controllable control valve as well as mechanical elements for transmitting the position of the fourth piston onto the control valve.

The mechanical elements for the transmission of the piston position preferably comprise a disc and a control sleeve.

In another favorable embodiment of the invention, at least one connection of the mechanical elements is provided as a mechanical stop acting on one side.

In another favorable embodiment of the subject matter of the invention, a fourth piston is provided, which is configured as a hollow piston and accommodates both the first piston and the third piston in such a fashion that a hydraulic chamber is delimited between the first piston and the third piston, which can be closed by a movement of the fourth piston relative to the master cylinder housing and constitutes a means for coupling the movement of the first piston and the third piston.

In a favorable improvement of the invention, a mechanical force-transmitting connection acting in an axial direction is provided between the second piston and the third piston.

In another favorable improvement of the subject matter of the invention, the pressure-supplying module is configured as a piston-and-cylinder assembly that is operable by means of a pneumatic actuator, and in that the pneumatic actuator can be operated independently by means of a control valve using the brake pedal and also irrespective of the brake pedal.

In another embodiment of the subject matter of the invention, the elastic element is interposed between the push rod and the fourth piston in terms of effect.

In another favorable design of the invention, the hydraulic chamber is in communication with a pressure fluid supply tank in the non-applied condition of the brake pedal.

In another design variant, the pneumatic actuator includes a housing whose interior is subdivided by a movable wall into a vacuum chamber and a working chamber, to which vacuum or atmospheric pressure can be applied by means of the control valve.

In another preferred embodiment of the subject matter of the invention, the vacuum chamber can be connected to an air suck-off device, e.g. a vacuum pump.

In another embodiment of the subject matter of the invention, the control valve is arranged in the inlet area of the master cylinder housing and is composed of a vacuum sealing seat, an atmospheric sealing seat and a valve member, with the vacuum sealing seat being designed at an axially movable first ring that is guided on the master cylinder housing, while the atmospheric sealing seat is designed at a second ring, that is also guided in the master cylinder housing and is axially movable in coaxial relationship to the first ring.

In another preferred embodiment of the invention, the independent actuation of the control valve is executed by means of an electromechanical actuator, preferably an electromagnet whose armature is connected to the first ring or is formed of the first ring, respectively.

Another favorable improvement of the subject matter of the invention involves that a reaction spring is interposed in terms of effect between the first piston and the fourth piston.

To be able to exactly dose the brake force desired by the driver, another variation provides that at least one sensor is provided to sense the position and the movement of the brake pedal, with the output signal of the sensor, e.g. a pedal angle of rotation and/or a pedal actuating travel, being sent to an electronic control unit and being used to activate the control valve.

Furthermore, at least one pressure sensor and at least one piston travel sensor can be fitted to the master cylinder, which sense the pressure introduced into the master cylinder and the travel of the second piston and convey this information to the electronic control unit.

In another embodiment of the subject matter of the invention, electric controlling and monitoring means are provided in the electronic control unit in order to control and monitor the vacuum pump.

Arrangements are made in another favorable improvement of the invention that the electronic control unit generates a brake light signal and sends it to the motor vehicle by way of an electronic operative connection. The electronic operative connection is constituted either by a data bus or as a direct line connection.

Communication means for the exchange of data with other vehicle components are provided in the electronic control unit according to another design variation.

Finally, still another favorable improvement of the subject matter of the invention involves that the electronic control unit is configured in such a manner as to receive brake pressure requests from other vehicle components and to realize them by actuation of the electrically controllable pressure-supplying module for triggering a master cylinder activation that is monitored by the pressure sensor and piston travel sensor.

One embodiment of the invention will be explained in detail in the following text by making reference to the accompanying drawing.

### BRIEF DESCRIPTION OF THE DRAWING

In the drawing,

FIG. 1 shows a schematic view of a brake system according to the invention.

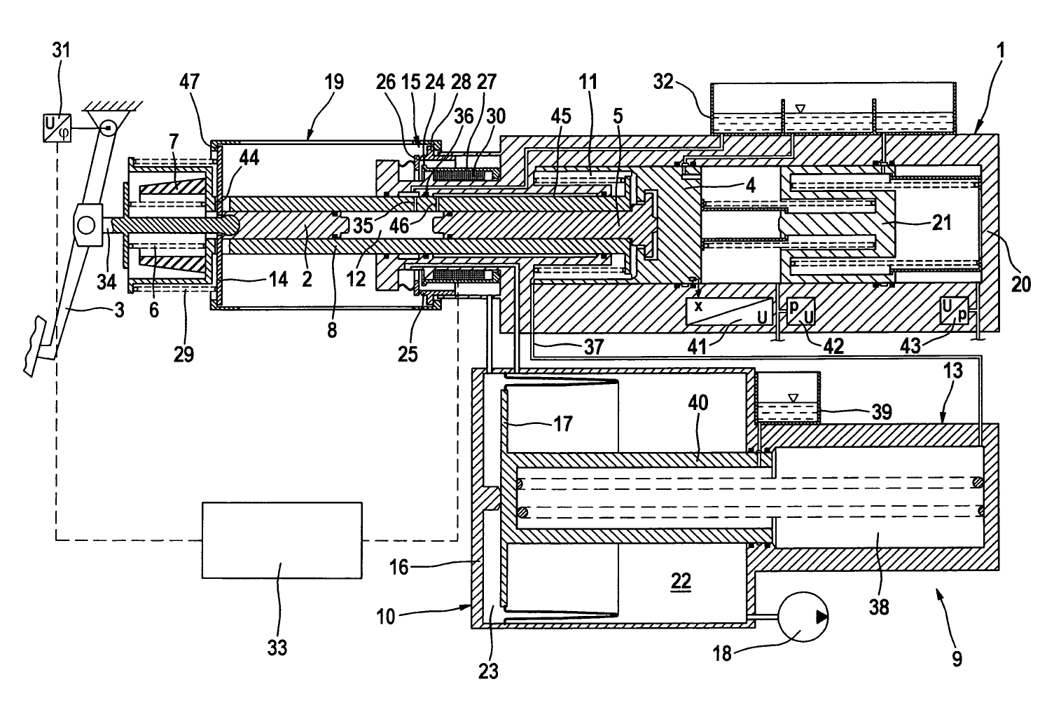

### DETAILED DESCRIPTION OF THE DRAWING

The brake system of the invention as illustrated in the drawing includes a brake pedal 3, which is connected to a first piston 2 in terms of effect by way of an operating rod 34. The brake pedal travel can be sensed using a sensor 31 for determining the angle of rotation. Further, a second piston 4 is provided, which represents an operating piston of a master brake cylinder 1. In the example shown, the master brake cylinder 1 is designed as a tandem master cylinder, in whose master cylinder housing 20 another piston 21 is connected downstream of the second piston 4. The wheel brakes of the vehicle can be connected to the master brake cylinder 1 by way of a controllable wheel brake pressure modulation module (not shown), and associated with the wheel brake pressure modulation module is an electronic control unit (which is also not shown). A travel sensor, which senses the actuating travel of the push rod 34 or the first piston 2, can be provided alternatively or in addition to the sensor for determining the angle of rotation shown.

Together with a third piston 5, the first piston 2 is displaceably guided in a fourth piston 8, and the first piston 2 and the third piston 5 delimit a hydraulic chamber 12, which forms a means to couple the movements of the first piston 2 and the third piston 5. The hydraulic chamber 12, on the one hand, is in connection through an opening or a passage 46 in the fourth piston 8 to a hydraulic chamber 45 that is otherwise closed and, on the other hand, through a hydraulic passage 35 in the fourth piston 8 to a pressure fluid supply tank 32, which is associated with the master brake cylinder 1 and is subjected to atmospheric pressure. A sealing element 36 mounted in the master cylinder housing 20 causes the passage 35 to be separated from the connection to the pressure fluid supply tank 32 upon a movement of the fourth piston 8 in relation to the master cylinder housing 20 and, upon further displacement, is connected to the closed hydraulic chamber 45. For pressure relief of this chamber in the inoperative state, it is suitable to design the sealing element 36, which is shown only schematically herein, as a piston seal, over which fluid can flow depending on the travel.

Furthermore, a compression spring 6 is arranged in terms of effect between the operating pedal 3 or the first piston 2, respectively, and the fourth piston 8, the said spring moving the first piston 2 through a disc 14 into abutment on a stop 44 that is designed at fourth piston 8, when the operating pedal 3 is not applied. An elastic element 7, e.g. an elastomeric spring, is also arranged in terms of effect between the operating rod 28 and the fourth piston 8, preferably in coaxial relationship or in parallel to the compression spring 6, and along with the compression spring 6 forms a pedal travel simulator, imparting to the operator the usual pedal feeling that corresponds to a customary brake pedal characteristics, when the brake system is operated. This implies that with a short brake pedal travel, the resistance rises slowly and increases overproportionally with a longer brake pedal travel. In addition, a reaction spring 29 acts between the disc 14 and the fourth piston 8.

The above-mentioned pistons 4, 5, 8, 21 are accommodated in the master cylinder housing 20, a space 11 being delimited between the second piston 4 and the third piston 5 and connecting by means of a hydraulic connection 37 to an electrically controllable pressure-supplying module 9, which allows pressurization of the space 11.

The pressure-supplying module 9 is essentially composed of a piston-and-cylinder assembly 13, which is operable by means of a pneumatic actuator 10, the above-mentioned hydraulic connection 37 connecting to its pressure chamber 38. The piston-and-cylinder assembly 13 is equipped with a pressure fluid supply tank 39. A hose coupling that leads to the pressure fluid supply tank 32 can be used instead of the illustrated pressure fluid supply tank 39 that is associated with the piston-and-cylinder assembly 13. The pneumatic actuator 10 has an actuator housing 16, in which a vacuum chamber 22 that is connected to a vacuum pump 18 or an equivalent air suck-off device as well as a ventilatable working chamber 23 are isolated from one another by a movable wall 17. The movable wall 17 is in a force-transmitting connection with the piston 40 (shown only schematically) of the piston-and-cylinder assembly 13, the piston delimiting the above-mentioned pressure chamber 38.

Used for the activation of the pneumatic actuator 10 is a control valve being fastened to the master cylinder housing 20, which has been assigned reference numeral 15 and can be actuated both mechanically and electromechanically. The control valve 15 is composed of a first, i.e. a vacuum sealing seat 24, a second, i.e. an atmospheric sealing seat 25, and an annular valve member 26 that cooperates with the sealing seats 24, 25. The vacuum sealing seat 24 is designed preferably at a first ring 27 guided on the master cylinder housing 20, whose position is controllable by electromechanical means, while the atmospheric sealing seat 25 is provided at a second ring 28, which is likewise guided in the master cylinder housing 20 and whose position is controllable by electromechanical means.

To position the first ring 27, an electric actuator, e.g. an electromagnet 30, is provided, whose armature is integrally designed with the first ring 27 and which allows an independent actuation of the control valve 15 irrespective of the operating pedal 3. To position the second ring 28, a control sleeve 19 is provided, which is connected to the above-mentioned disc 14 on one side and to the second ring 28 on the other side, and at least one of these connections is constituted as a stop acting on one side so that the control sleeve 19 must transmit tractive forces only. To allow unimpeded passage of air under atmospheric pressure to the control valve 15, the control sleeve 19 includes radial apertures.

Upon brake pedal application, a suitable spring action initially causes displacement of the first piston 2 together with the disc 14, the control sleeve 19, the second ring 28 and the valve member 26 relative to the master cylinder housing 20. When the valve member 26 is seated on the vacuum sealing seat 24, said will be closed and the atmospheric sealing seat 25 opened, with the result that the working chamber 23 of the pneumatic actuator 10 is ventilated in the pressure-supplying module 9 and the resulting action of force on the movable wall 17 actuates the piston 40 of the piston-and-cylinder assembly 13. The so produced hydraulic pressure in the pressure chamber 38 is supplied through the hydraulic connection 37 to the space 11 in the master cylinder housing 20.

Thus, the master brake cylinder 1 is operated, on the one hand, and the hollow piston 8 is pressed back in opposition to the direction of operation, on the other hand. This action closes the atmospheric sealing seat 25 and stops further pressure buildup in the space 11 because the hollow piston 8 stays in a position of balance in which the operating force is balanced by a portion of the actuator force that is defined due to the surface ratios in the space 11. When the pedal force changes, a new position of balance develops due to a corresponding opening and closing of valve seats 24 and 25. This arrangement could also be referred to as a pneumatic position controller for the hollow piston 8, which compensates different pedal operating forces by automatically adapted actuator forces. Due to the hollow piston 8 being permanently retained in the same position, the pedal force is determined only by the forces of the spring 6 and 7, but not by the operating condition of the master cylinder 1.

With insufficient or lacking booster pressure in the space 11, the hollow piston 8 will displace into the space 11 due to the forces exerted by the operating rod 34 by way of springs 6 and 7. As a result, the passage 35 provided in the wall of the fourth, i.e. hollow piston 8, will override the seal 27, whereby the connection between the hydraulic chamber 12 and the pressure fluid supply tank 32 is interrupted. The pressure fluid volume, which is thereby enclosed in the hydraulic chamber 12, couples the movement of the first piston 2 and the third piston 5. Since the first piston 2 is coupled through the operating rod 34 to the pedal 3 and the third piston 5 is coupled in the operating direction to the master cylinder piston 4, a direct through grip from the brake pedal 3 to the master cylinder is automatically established in the event of insufficient or lacking booster pressure in space 11. This hydraulic coupling is controlled exclusively by a movement of the fourth piston 8 relative to the master cylinder housing 20 and is therefore independent of the operating condition of the master cylinder 1. For activation of the coupling action, only the small displacement travel of the hollow piston 8 relative to the housing 20 is required to close the passage 35. Loss in pedal travel is thereby avoided, which would be inevitable in the case of a direct through grip from the pedal to the master cylinder piston 4 by way of a mechanical contact between the first piston 2 and the third piston 5. A mechanical through grip of this type is also possible in the brake system of the invention and represents a lowest fallback mode, which enables operation of the master cylinder when the hydraulic coupling fails, e.g. due to leakage, involving loss in pedal travel though.

The brake system of the invention can operate in different modes of operation. In a non-operative state, the same pressure prevails in both chambers 22, 23 of the pneumatic actuator 10 because the vacuum sealing seat 24 is open.

In a purely electrically controlled operating mode, the control valve 15 is actuated by way of the electromechanical actuator 43 in order to ventilate the working chamber 23 of the pneumatic actuator 10. As this occurs, the above-mentioned vacuum sealing seat 24 is closed and the atmospheric sealing seat 25 opened. Due to the action of force of the introduced air at the movable wall 17, hydraulic pressure develops in the pressure chamber 38 of the piston-and-cylinder assembly 13 and is supplied to the space 11 through the line 37. This pressure causes the second piston 4 and the additional piston 21 of the master cylinder 1 to displace to the right, as viewed in the drawing, so that pressure fluid flows into both brake circuits (only indicated).

In a first pedal-controlled operating mode, application of the brake pedal 3 brings about a mechanical activation of the control valve 15, having the effect explained above as a result. Of course, a combined operating mode with a simultaneous pedal-controlled and electric activation of the control valve 15 is also possible. This mode is employed, for example, in order to achieve the function of the brake assist system, which is well known to the one skilled in brake technology, implying that defined brake-pedal-controlled brake operations are accelerated and intensified.

In another pedal-controlled operating mode, which corresponds to a first fallback mode, hydraulic pressure cannot build up in the space 11 due to a disturbance in the sequences described hereinabove, with the result that displacement of the hollow piston 8 cannot be counteracted by a returning pressure force and the above-described condition of a hydraulic coupling from the first piston to the third piston brings about a non-boosted transmission of force from the actuating rod to the master brake cylinder 1 via the first piston 2, the pressure fluid enclosed in the hydraulic chamber 12, the third piston 5, and the second piston 4 coupled to piston 5. On account of using the hydraulic locking, pedal travel loss will not occur with the aid or chamber 12, unless pressure build up in this chamber is not possible due to additional malfunction. In this case, a purely mechanical force transmission from the first piston 2 to the third piston 5 occurs by direct mechanical contact in another fallback mode. The master brake cylinder 1 is actuated exclusively by using muscle power in the fallback operating modes.

The invention at topic achieves a brake system of a simple design, in which the brake pedal characteristics does not depend on the actuating condition of the remaining brake system, with the result that in the event of a brake operation by the driver, the pedal feeling can be disturbed neither by the simultaneous existence of an independent brake operation, nor by any other control activities of the brake system such as anti-lock control, traction control, or driving stability control.

The additional advantage of the brake system can be seen in its simpler design compared to conventional brake systems. Vehicles equipped with an electronic stability control function (ESP) e.g. require a special ESP hydraulics, which is more complicated than a normal ABS hydraulics because it must also inhere the ability of building up wheel brake pressures in excess of the master cylinder pressure, what is in contrast to the ABS hydraulics. In contrast thereto, the brake system disclosed manages with a simple ‘ABS’ hydraulic module containing only eight solenoid valves on the side connected downstream of the master cylinder.

1.-21. (canceled)

22. A brake system for motor vehicles comprising
a master cylinder (1) with a master cylinder housing (20) to which wheel brake cylinders are connectable,
a first piston (2) which is coupled to a brake pedal (3) by way of a push rod (34) that transmits actuating forces,
a second piston (4) used to actuate the master cylinder (1),
a third piston (5) which can be actuated hydraulically by the first piston (2),
with at least one elastic element (6, 7) forming a pedal travel simulator that imparts a pleasant pedal feeling to the operator in the ‘brake-by-wire’ operating mode,
an arrangement to couple the movements of the first piston (2) and the third piston (5),
a space (11) to which hydraulic pressure is applicable, whose pressurization brings about a hydraulic action of force on the second and the third pistons (4, 5),
as well as an electrically controllable pressure-supplying module (9), which allows both filling the space (11) with pressure fluid and evacuating it, wherein a fourth piston (8) is provided, which can be acted upon by two oppositely directed forces by way of the elastic element (6, 7) on the input side and by the hydraulic pressure in the space (11) on the outlet side, and wherein a means (14, 19, 15) is provided in order to render the pressure-supplying module (9) controllable depending on the position of the fourth piston (8) that results from the force application, in addition to the electric controllability.

23. The brake system as claimed in claim 22,
comprising a both mechanically and electrically controllable control valve (15) as well as mechanical elements (14, 19) for transmitting the position of the fourth piston (8) onto the control valve (15) in order to control the pressure-supplying module (9) depending on the position of the fourth piston (8).

24. The brake system as claimed in claim 23,
wherein the mechanical elements for the transmission of the piston position comprise a disc (14) and a control sleeve (19).

25. The brake system as claimed in claim 24,
wherein the control valve (15) has an electromagentic actuator (30) whose armature is connected to the first ring (27) or is formed of the first ring (27), respectively.

26. The brake system as claimed in claim 23,
wherein the control valve (15) is arranged in the inlet area of the master cylinder housing (20) and is composed of a vacuum sealing seat (24), an atmospheric sealing seat (25) and a valve member (26), with the vacuum sealing seat (24) being designed at an axially movable first ring (27) that is guided on the master cylinder housing (20), while the atmospheric sealing seat (25) is designed at a second ring (28), that is also guided in the master cylinder housing (20) and is movable coaxially relative to the first ring (27).

27. The brake system as claimed in claim 23, wherein at least one connection of the mechanical elements is provided as a mechanical stop (47) acting on one side.

28. The brake system as claimed in claim 22,
wherein the fourth piston (8) is configured as a hollow piston and accommodates both the first piston (2) and the third piston (5) in such a fashion that a hydraulic chamber (12) is delimited between the first piston (2) and the third piston (5), which can be closed by a movement of the fourth piston (8) relative to the master cylinder housing (20) and constitutes a means for coupling the movement of the first piston (2) and the third piston (5).

29. The brake system as claimed in claim 28,
wherein a mechanical force-transmitting connection acting in an axial direction is provided between the second piston (4) and the third piston (5).

30. The brake system as claimed in claim 28,
wherein the hydraulic chamber (12) is in communication with a pressure fluid supply tank (32) when the brake pedal (3) is not actuated.

31. The brake system as claimed in claim 22,
wherein the elastic element (6) is interposed between the push rod (34) and the fourth piston (8) in terms of effect.

32. The brake system as claimed in claim 22,
wherein the pressure-supplying module (9) is configured as a piston-and-cylinder assembly (13) that is operable by means of a pneumatic actuator (10), and wherein the pneumatic actuator (10) can be operated independently by means of a control valve (15) using the brake pedal (3) and also irrespective of the brake pedal (3).

33. The brake system as claimed in claim 32, wherein the pneumatic actuator (10) includes a housing (16) whose interior is subdivided by a movable wall (17) into a vacuum chamber (22) and a working chamber (23), to which vacuum or atmospheric pressure can be applied by means of the control valve (15).

34. The brake system as claimed in claim 33,
wherein the vacuum chamber (22) can be connected to an air suck-off device, e.g. a vacuum pump (18).

35. The brake system as claimed in claim 22,
wherein a reaction spring (29) is interposed in terms of effect between the first piston (2) and the fourth piston (8).

36. The brake system as claimed in claim 22,
wherein an angle-of-rotation sensor (31) is provided to sense position and movement of the brake pedal, with the output signal of the sensor being sent to an electronic control unit (33) and being used to activate the control valve (15).

37. The brake system as claimed in claim 36,
wherein at least one pressure sensor (42, 43) and at least one piston travel sensor (41) are fitted to the master cylinder (1), which sense the pressure introduced into the master cylinder (1) and the travel of the second piston (4) and convey this information to the electronic control unit (33).

38. The brake system as claimed in claim 36,
wherein the electronic control unit (33) is configured in such a manner as to receive brake pressure requests from other vehicle components and to realize them by actuation of the electrically controllable pressure-supplying module (9) for triggering a master cylinder activation that is monitored by the pressure sensor (42, 43) and piston travel sensor (41).

39. The brake system as claimed in claim 36, wherein the electronic control unit (33) is associated with the pressure-supplying module (9).
